(19) United States
(12) Patent Application Publication
(10) Pub. No.: US 2024/0399678 A1
(43) Pub. Date: Dec. 5, 2024

(54) SPAR CAP FOR A WIND TURBINE BLADE

(71) Applicant: LM Wind Power A/S, Kolding (DK)

(72) Inventors: Klavs JESPERSEN, Kolding (DK); Lars NIELSEN, Kolding (DK)

(21) Appl. No.: 18/694,808

(22) PCT Filed: Nov. 9, 2022
(86) PCT No.: PCT/EP2022/081323

§ 371 Date: Mar. 22, 2024

(30) Foreign Application Priority Data
Nov. 10, 2021 (EP) 21207492.6

(51) Int. Cl. B29C 70/00; B29C 70/42; B29L 31/08; F03D 1/06

(52) U.S. Cl. CPC B29C 70/003; B29C 70/42; F03D 1/0681; B29L 2031/085

(57) ABSTRACT

A spar cap for a wind turbine blade, comprising a load-carrying structure including a primary laminate and a secondary laminate arranged with an overlap in a longitudinal axis of the spar cap, wherein the width of the secondary laminate being at least 1.1 times greater than the width of the primary laminate.

### TECHNICAL FIELD

The present disclosure relates to a spar cap for a wind turbine blade, in particular an offline moulded spar cap, and a method for moulding such a spar cap.

### BACKGROUND

Wind power provides a clean and environmentally friendly source of energy. Wind turbines usually comprise a tower, generator, gearbox, nacelle, and one or more rotor blades. The wind turbine blades capture kinetic energy of wind using known airfoil principles. Modern wind turbines may have rotor blades that exceed 100 meters in length.

Wind turbine blades are usually manufactured by forming two shell parts or shell halves from layers of woven fabric or fibre and resin. Spar caps, which are also called main laminates, are placed or integrated in the shell halves and may be combined with shear webs or spar beams to form structural support members. Spar caps or primary laminates may be joined to, or integrated within, the inside of the suction side and pressure side halves of the shell.

As the size of wind turbine blades increases, various challenges arise from such blades being subjected to increased forces during operation, requiring improved reinforcing structures. In some known solutions, pultruded fibrous strips of material are used. Pultrusion is a continuous process in which fibres are pulled through a supply of liquid resin and then heated in an open chamber where the resin is cured. Such pultruded strips can be cut to any desired length.

However, the manufacturing of large reinforcing structures, such as spar caps, can be challenging. In particular, many limitations still exist in the ability to stay within required tolerances during known processes for manufacturing spar caps. Also, some known spar cap moulding methods are quite tedious and ineffective and may result in undesired damage to the pultruded elements when demoulding the spar cap from the spar cap mould. Other potential problems include wrinkle formation, unsatisfactory resin impregnation or air pockets formed during known moulding processes for forming spar caps.

### SUMMARY

On this background, it may be seen as an object of the present disclosure to provide a spar cap which has increased stiffness and buckling resistance while allowing efficient manufacture thereof.

Another object of the present disclosure is to provide an improved method of manufacturing such a spar cap for a wind turbine blade, which is more efficient and less time-consuming, and which reduces the cycle time of the shell mould for the wind turbine blade and further minimises unsatisfactory resin impregnation or air pockets formed during the manufacturing process.

One or more of these objects may be met by aspects of the present disclosure as described in the following.

A first aspect of this disclosure relates to a spar cap, preferably being separately moulded, for a wind turbine blade, the wind turbine blade extending along a longitudinal blade axis from a root to a tip, the wind turbine blade comprising a root region and an airfoil region with the tip, the wind turbine blade comprising a chord line extending between a leading edge and a trailing edge, the wind turbine blade comprising an aerodynamic exterior blade surface including a pressure side and a suction side, the spar cap extending along a longitudinal axis configured to be parallel to the longitudinal blade axis when the spar cap forms part of the wind turbine blade, the spar cap comprising:
a primary laminate comprising a plurality of first fibre layers embedded in a first polymer matrix, the primary laminate preferably including:
   a root section with a root end configured for being oriented towards the root of the wind turbine blade,
   a tip section with a tip end configured for being oriented towards the tip of the wind turbine blade,
   a body section between the root section and the tip section, the body section having a bottom surface and a top surface, wherein the bottom surface is configured for being adjacent to and oriented towards one of the pressure side and suction side of the wind turbine blade,
   a leading edge side configured for being oriented towards the leading edge of the wind turbine blade, and
   a trailing edge side configured for being oriented towards the trailing edge of the wind turbine blade;
preferably a first core material arranged adjacent to at least a longitudinal section of one of the leading edge side and the trailing edge side of the body section so that a top surface of the first core material is aligned with the adjacent top surface of the body section; and
a secondary laminate comprising a plurality of second fibre layers embedded in a second polymer matrix, the secondary laminate preferably being arranged on the top surface of the primary laminate,
   wherein the first core material is co-embedded in the first polymer matrix and/or the second polymer matrix, and wherein the secondary laminate preferably extends beyond the primary laminate and onto the top surface of the first core material, wherein preferably a width of the primary laminate and a width (W_{SL}) of the secondary laminate extend between a trailing edge side and a leading edge side of the respective one of the primary laminate and the secondary laminate, the width of the secondary laminate being at least 1.1 times, preferably 1.2 times, more preferably 1.3 times, even more preferably 1.4 times greater than the width of the primary laminate, wherein preferably the primary laminate and the secondary laminate overlap in the longitudinal axis of the spar cap preferably so that a height of the spar cap at the overlap comprises the height of the plurality of first fibre layers and the height of the plurality of second fibre layers.

As wind turbine blades become longer, the stiffness requirements of the spar caps significantly increase. However, there is an upper boundary limiting the maximum infusible laminate thickness. The inventors have found that by providing a spar cap that, in addition to a primary laminate, further comprises a secondary laminate overlapping, e.g. by being placed on top of, the primary laminate and having a substantially different width compared to the primary laminate, and e.g. extending onto adjacent core material, the stiffness and buckling resistance of the spar cap may be improved without breaching the maximum infusible laminate thickness. The inventors have found that when infusing a blade shell laminate greater than 70 mm in thickness, it becomes increasingly difficult to ensure good infusion quality using conventional infusion processes.

It has further been found that such an arrangement can advantageously be moulded separately in an offline mould, i.e. separate from the remaining parts of the wind turbine blade, such as the shell. This may reduce cycle time of the shell mould, as placing the pre-cured and integrated spar cap requires less time than building up the spar cap from separate layers or components.

In the present disclosure, the term “offline moulded spar cap” is interpreted as a spar cap that has been moulded in a dedicated spar cap mould separately from the remaining parts of the wind turbine blade. The spar cap is intended to be subsequently moved to a shell mould so as to be incorporated in a shell part for the wind turbine blade. Thus, the term “offline” refers to the manufacture of the spar cap happens “offline” of the remaining parts of the wind turbine blade. This is in contrast with the conventional manufacturing method wherein the fibre material of the spar cap is co-infused with the shell part of the wind turbine blade.

Additionally, the spar cap may be covered by one or more cover layers, typically at most two cover layers, either provided during the offline moulding or when incorporated into the wind turbine blade. However, the purpose of the one or more cover layers are to protect the spar cap but not to reinforce the wind turbine blade. The cover layers may be formed of a fibre material. The secondary laminate is preferably significantly thicker, e.g. at least twice as thick, than the cover layers. Preferably, the cover layer may comprise bi-axial fibre layer.

Additionally or alternatively, the plurality of first fibre layers of the primary laminate may include at least 10, 20, 30, or even at least 40 first fibre layers. Additionally or alternatively, the plurality of first fibre layers of the primary laminate may include up to 60 layers. The plurality of first fibre layers may comprise carbon fibre layers, glass fibre layers, or a hybrid fibre layer, such as a combination of glass and carbon fibre layers. The plurality of second fibre layers may include at least 5, 10, or even at least 15 second fibre layers. Additionally or alternatively, the plurality of second fibre layers of the secondary laminate may include up to 30 layers, such as in the range from 5-30 layers. The plurality of second fibre layers may comprise carbon fibre layers, glass fibre layers, or a hybrid fibre layer, such as a combination of glass and carbon fibre layers. The first and/or second fibre layers may be multidirectional, such as biaxial or triaxial, but are preferably unidirectional. The primary laminate may have a maximum thickness in the range of 50-80 mm. The maximum thickness of the primary laminate may be at least 60 mm or at least 70 mm. The secondary laminate may have a maximum thickness of at least 12 mm or preferably at least 40 mm, or alternatively be in the range of 12-50 mm. The maximum thickness of the secondary laminate may be, by order of increasing preference, at least 8%, at least 10%, at least 12%, at least 14%, at least 16%, at least 18%, or preferably at least 20% of the maximum thickness of the primary laminate.

Additionally or alternatively, the first polymer matrix may be identical to the second polymer matrix so that the secondary laminate may be co-embedded with the primary laminate in the same polymer matrix.

Alternatively, the first polymer matrix may be different from the second polymer matrix. For instance, the primary laminate may be cured separately from the secondary laminate.

Additionally or alternatively, the body section of the primary laminate may have a substantially constant height between the bottom surface and the top surface preferably along the longitudinal axis and/or between the leading edge side and the trailing edge side.

Additionally or alternatively, the width of the secondary laminate may be at least 1.5 or even 2 times or even 3 times the width of the primary laminate. For example, the width of the primary laminate may be at least 20 cm or in the range of 20 cm to 120 cm, preferably in the range of 30 cm to 100 cm. The width of the secondary laminate may be at least 40 cm or in the range of 40 cm to 250 cm, preferably in the range of 60 cm to 200 cm.

In the context of the present disclosure, the term “overlap” does not imply the order of stacking. Thus, the secondary laminate may be placed on top of the primary laminate or vice versa unless otherwise specified. Further, the secondary laminate may fully or partially overlap the primary laminate in the longitudinal axis. In some embodiments, the secondary laminate may fully overlap the primary laminate in the longitudinal axis and may be placed on a top surface of the primary laminate, e.g. of the body section of the primary laminate. In other embodiments the secondary laminate may partially overlap the primary laminate in the longitudinal axis and may in such case extend beyond the primary laminate in the longitudinal axis, preferably beyond the root end of the primary laminate. For the partial overlapping laminates, glass fibres, e.g. glass fibre fabric layers, in particular unidirectional ones, are an advantageous material selection for the lowermost laminate of the overlap. The material of the uppermost laminate of the overlap may be carbon fibres, e.g. such as pultrusions or carbon fibre fabric layers, in particular unidirectional ones.

Additionally or alternatively, the spar cap may further comprise a second core material adjacent to a longitudinal section of the other one of the leading edge side and the trailing edge side of the primary laminate so that a top surface of the second core material is aligned with the top surface of the body section of the primary laminate. The secondary laminate may extend beyond the primary laminate and on to the second core material. The second core material may be co-embedded in the first polymer matrix and/or the second polymer matrix.

The material of the first and/or the second core may comprise or consist essentially of balsa wood or foamed polymer, such as open-cell foamed polymer or closed-cell foamed polymer. The material of the first core material and the second core material may be identical or may be different. The first core material may be formed separately from the second core material. The first core material and/or the second core material may be sandwiched between a number of fibre-reinforced skin layers on the exterior side, i.e. facing the mould surface, and a number of fibre-reinforced cover layers.

Additionally or alternatively, the first core material and/or the second core material may each comprise a primary section and a tapering section. The tapering section may extend from the primary section to the primary laminate. The tapering section may taper in thickness from the height of the primary section to the height of the respective one of the leading edge side or the trailing edge side of the primary laminate. The secondary laminate may extend beyond the primary laminate and on to at least the tapering section of the first core material and/or second core material. The secondary laminate may preferably further extend on to the primary section of the first core material and/or second core material.

Additionally or alternatively, a height of the root section and/or the tip section of the primary laminate may taper off towards a root end and/or towards a tip end of the primary laminate, respectively.

Additionally or alternatively, a tip end and/or a root end of the secondary laminate may be distanced from the tip end and/or the root end of the primary laminate, respectively.

Additionally or alternatively, the tip end and/or the root end of the secondary laminate may be arranged between and at a distance from the tip section and/or the root section of the primary laminate, respectively.

Additionally or alternatively, a height of the secondary laminate may taper off towards the root end and/or towards the tip end of the secondary laminate.

Additionally or alternatively, the secondary laminate may be arranged so that, when the spar cap forms part of the wind turbine blade, the root end of the secondary laminate is at a location between 3%-10%, preferably 5%, of the total length of the wind turbine blade.

Additionally or alternatively, the secondary laminate may be arranged so that, when the spar cap is incorporated into the wind turbine blade, the tip end of the secondary laminate is at a location between 65%-85%, preferably 75%, of the total length of the wind turbine blade.

Additionally or alternatively, the secondary laminate may extend from a location at 5% or 10% of the total length of the wind turbine blade to a location at 75% of the total length of the wind turbine blade.

Additionally or alternatively, the secondary laminate may be arranged between 3% to 40% along the length of the primary laminate. In other words, the root end of the secondary laminate may be located at 3% of the length of the primary laminate from the root end of the primary laminate, and the tip end of the secondary laminate may be located at 40% of the length of the primary laminate from the root end of the primary laminate.

A second aspect of this disclosure relates to a wind turbine blade extending along a longitudinal axis from a root to a tip, the wind turbine blade comprising a root region and an airfoil region with the tip, the wind turbine blade comprising a chord line extending between a leading edge and a trailing edge, the wind turbine blade comprising an aerodynamic exterior blade surface including a pressure side and a suction side. The wind turbine blade comprises one or more spar caps according to the first aspect of this disclosure. The one or more spar caps include at least a first spar cap. The bottom surface of the body section of the first spar cap is arranged adjacent to and oriented towards one of the pressure side and suction side of the wind turbine blade.

Additionally, the one or more spar caps may further include a second spar cap, which is also according to the first aspect of this disclosure. The bottom surface of the body section of the second spar cap may be arranged adjacent to and oriented towards the other one of the pressure side and suction side of the wind turbine blade.

A third aspect of this disclosure relates to a method of moulding, preferably offline moulding, a spar cap for a wind turbine blade, the wind turbine blade extending along a longitudinal axis from a root to a tip, the wind turbine blade comprising a root region and an airfoil region with the tip, the wind turbine blade comprising a chord line extending between a leading edge and a trailing edge, the wind turbine blade comprising an aerodynamic exterior blade surface including a pressure side and a suction side. The method comprises the steps of:
providing a first mould with a mould surface, the mould surface preferably being shaped to correspond to an interior surface of a shell of the wind turbine blade;
arranging a plurality of first fibre layers, preferably directly, on the mould surface for forming a primary laminate preferably having:
   a root section with a root end adapted for being oriented towards the root of the wind turbine blade,
   a tip section with a tip end adapted for being oriented towards the tip of the wind turbine blade,
   a body section extending from the root section to the tip section, the body section having a bottom surface and a top surface, the bottom surface being adjacent to and oriented towards one of the pressure side and suction side of the wind turbine blade,
   a leading edge side adapted for being oriented towards the leading edge of the wind turbine blade, and
   a trailing edge side adapted for being oriented towards the trailing edge;
preferably arranging a first core material, preferably directly, on the mould surface adjacent to at least a longitudinal section of one of the leading edge side or the trailing edge side of the primary laminate so that a top surface of the first core material is aligned with an adjacent top surface of the body section of the primary laminate;
arranging a plurality of second fibre layers in the mould, e.g. onto the body section of the primary laminate and further on to the first core material, to form a secondary laminate configured to form part of a load-carrying structure of the spar cap, the primary laminate;
embedding, and preferably infusing, the plurality of first fibre layers and the plurality of second fibre layers in a resin; and
curing the resin to form a first polymer matrix so that the plurality of first fibre layers forming the primary laminate, the plurality of second fibre layers forming the secondary laminate, and preferably the first core material are co-embedded in the first polymer matrix so as to form a load-carrying structure of the spar cap for the wind turbine blade, preferably wherein a width of the second laminate being at least 1.1 times a width of the primary laminate, wherein the primary laminate and the secondary laminate overlap in the longitudinal axis of the spar cap so that a height of the spar cap at the overlap comprises the height of the plurality of first fibre layers and the height of the plurality of second fibre layers.

Additionally, the method may further comprise a step of arranging a first mould inlay on the mould surface adjacent to at least a longitudinal section of one of the leading edge side or the trailing edge side of the primary laminate so that a top surface of the first mould inlay is aligned with an adjacent top surface of the body section of the primary laminate, wherein the plurality of second fibre layers is arranged onto the body section of the primary laminate and further onto the first mould inlay, wherein the method preferably comprises a step of removing the first mould inlay after the step of infusion or curing.

Additionally or alternatively, the method may further comprise a step of arranging a second mould inlay on the mould surface adjacent to the other one of the leading edge side and the trailing edge side of the primary laminate so that a top surface of the second core material is aligned with the top surface of the body section of the primary laminate, wherein the plurality of second fibre layers is further arranged onto the second core material, and wherein the second core material is co-embedded together with the primary laminate, the secondary laminate, and the first core material in the first polymer matrix.

Additionally or alternatively, the method may comprise a step of arranging a second core material, preferably directly, on the mould surface adjacent to the other one of the leading edge side and the trailing edge side of the primary laminate so that a top surface of the second core material is aligned with the top surface of the body section of the primary laminate. The step of arranging the plurality of second fibre layers may comprise arranging the plurality of second fibre layers further on to the second core material. The second core material may be infused and co-embedded together with the primary laminate, the secondary laminate, and the first core material in the first polymer matrix.

Additionally or alternatively, the method may further comprise the steps of:
demoulding the spar cap;
arranging the spar cap on one or more shell layers arranged in a second mould, which is different from the first mould;
infusing the one or more shell layers with a resin; and
curing the resin to form a third polymer matrix in which the one or more shell layers and the spar cap are co-embedded so as to form a wind turbine blade shell part for the wind turbine blade.

The third polymer matrix may be the same type of resin or it may be a different type of resin. Resin types may include polyester, epoxy, vinylester, polyurethane or thermoplastic or a similar resin.

A person skilled in the art will appreciate that any one or more of the above aspects of this disclosure and embodiments thereof may be combined with any one or more of the other aspects of this disclosure and embodiments thereof.

### BRIEF DESCRIPTION OF THE DRAWINGS

Embodiments of this disclosure will be described in more detail in the following with regard to the accompanying figures. The figures show one way of implementing the present invention and are not to be construed as being limiting to other possible embodiments falling within the scope of the attached claim set.

FIG. 1 is a schematic perspective view of a wind turbine.

FIG. 2 is a schematic perspective view of a wind turbine blade for a wind turbine as shown in FIG. 1.

FIG. 3 is a schematic perspective view of a first spar cap according to the present disclosure for incorporation in the wind turbine blade of FIG. 2.

FIG. 4A is a schematic cross-sectional view of the spar cap along line A-A shown in FIG. 3.

FIG. 4B is a schematic cross-sectional view of the spar cap along line B-B shown in FIG. 3.

FIG. 5 is a schematic perspective view of a second spar cap according to the present disclosure for incorporation in the wind turbine blade of FIG. 2 using mould inlays.

FIG. 6 is a schematic perspective view of the second spar cap shown in FIG. 5 after mould inlays have been removed.

FIG. 7A is a schematic cross-sectional view of a third spar cap.

FIG. 7B is a schematic cross-sectional view of a fourth spar cap.

FIG. 7C is a schematic cross-sectional view of the third and fourth spar cap at the line C-C shown in FIGS. 7A and 7B.

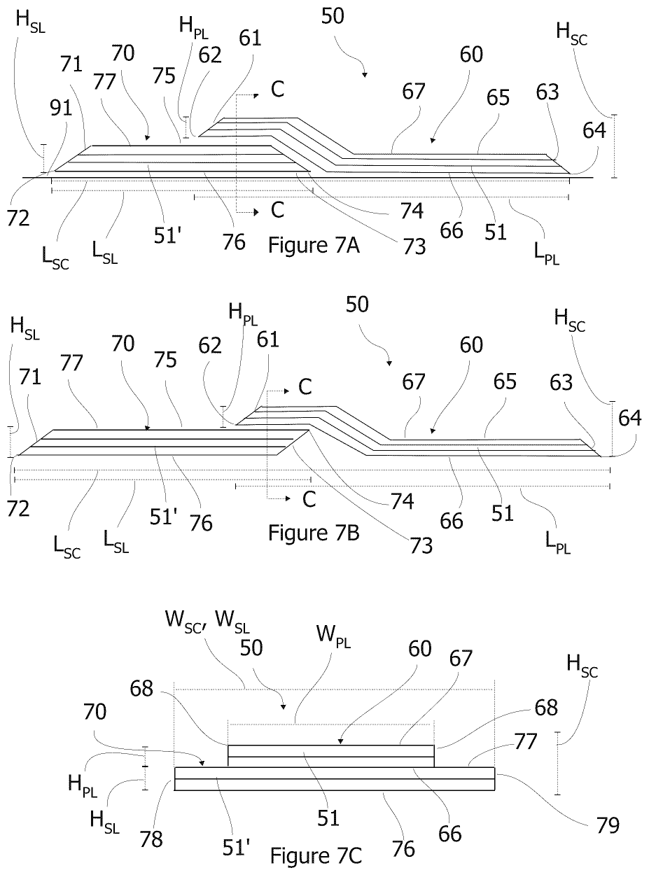

The elements of the figures are not shown to scale. In particular, the spanwise extent of the spar cap is shown compressed for illustrative purposes. Further, a gap is shown between the primary and secondary laminates in FIGS. 7A-7B for illustration purposes. In practice, the primary and secondary laminates are arranged in close proximity or even co-embedded in the same resin.

### DETAILED DESCRIPTION OF THE INVENTION

In the following figure description, the same reference numbers refer to the same elements and may thus not be described in relation to all figures. Further, a prime suffix denotes another element of the same type, e.g. 80 denotes the first core material and 80′ denotes the second core material.

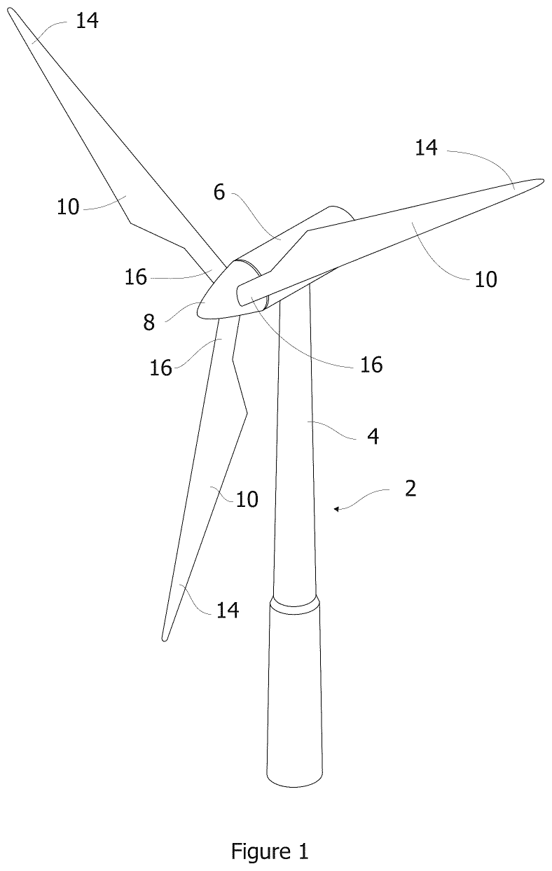

FIG. 1 illustrates a conventional modern upwind wind turbine 2 according to the so-called “Danish concept” with a tower 4, a nacelle 6 and a rotor with a substantially horizontal rotor shaft which may include a tilt angle of a few degrees. The rotor includes a hub 8 and three blades 10 extending radially from the hub 8, each having a blade root 16 nearest the hub and a blade tip 14 furthest from the hub 8.

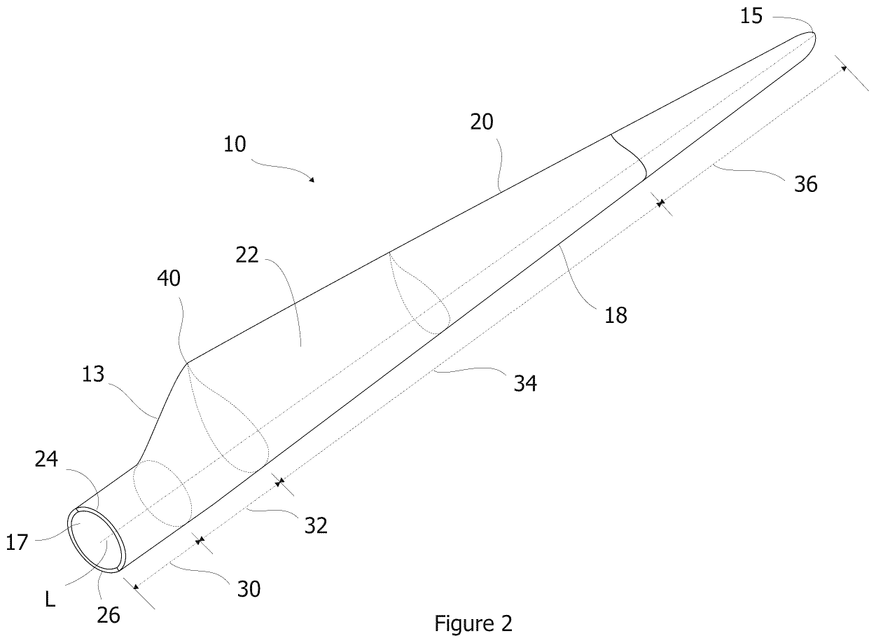

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub 8, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root region 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

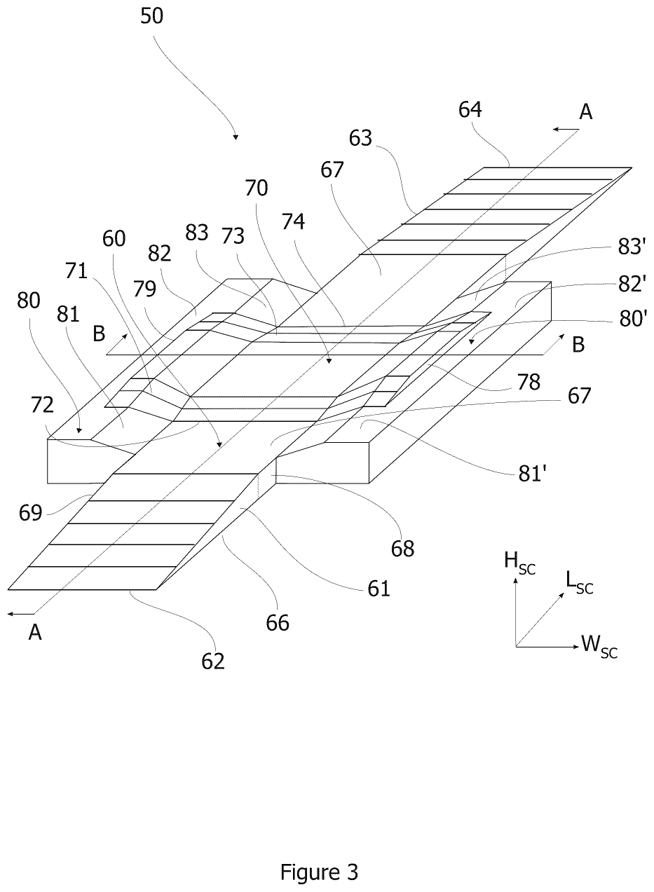

Turning to FIG. 3, a spar cap 50 for the wind turbine blade 10 as shown in FIG. 2 is illustrated. The spar cap 50 extends along a longitudinal axis L_{SC} configured to be parallel to the longitudinal blade axis L (as seen in FIG. 2) when the spar cap 50 forms part of the wind turbine blade 10 of FIG. 2. The spar cap 50 is not illustrated to scale. In practice, the spar cap 50 has a much greater extent along the longitudinal axis L_{SC} than both its height H_{SC} and width W_{SC}. The spar cap 50 comprises a primary laminate 60, a secondary laminate 70, a first core material 80, and a second core material 80′.

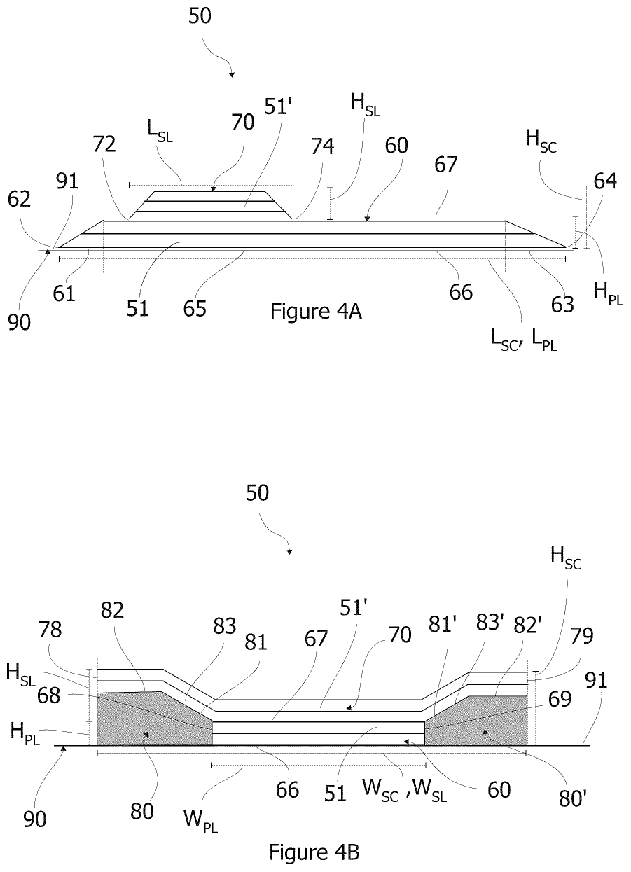

The primary laminate 60 comprises a plurality of first fibre layers. The number of layers indicated near numerals 61 and 63 are schematical, in practice the number of layers can exceed 40 layers. The plurality of first fibre layers comprises a combination of glass fibre fabric layers and carbon fibre fabric layers oriented unidirectionally along the longitudinal axis L_{SC}. The primary laminate 60 includes a root section 61 with a root end 62. The root end 62 is intended for being oriented towards the root 16 of the wind turbine blade 10 when incorporated therein. The primary laminate 60 further comprises a tip section 63 with a tip end 64 for being oriented towards the tip 14 of the wind turbine blade 10 when incorporated therein. The boundaries of the root section 61 and the tip section 63 are indicated with dashed lines as shown in FIGS. 3 and 4A. The plurality of first fibre layers of the primary laminate 60 is arranged with ply drops so that the height H_{PL} of the root section 61 and the tip section 63 of the primary laminate 60 tapers off towards the root end 62 and towards the tip end 64 of the primary laminate 60, respectively. Thus, the cross-section of the primary laminate 60 along the longitudinal axis L_{SC} is substantially trapezoidal as seen in FIG. 4A. In some embodiments, this cross-section is symmetrical but may in other embodiments be skewed towards either the root end 62 or the tip end 64. A body section 65 of the primary laminate 60 is arranged between the root section 61 and the tip section 63, i.e. between the boundaries thereof as indicated by the dashed lines as shown in FIGS. 3 and 4A. The body section 65 has a bottom surface 66 and a top surface 67. The body section 65 is thus box shaped with a substantially constant height H_{PL} between the bottom surface 66 and the top surface 67 from the boundary of the root section 61 to boundary of the tip section 63. The bottom surface 66 is intended for being adjacent to and oriented towards one of the pressure side 24 and suction side 26 of the wind turbine blade 10 and therefore is shaped to conform to an interior surface of the shell layers of the wind turbine blade 10. The primary laminate 60 further includes a leading edge side 68 configured for being oriented towards the leading edge 18 of the wind turbine blade 10, and a trailing edge side 69 configured for being oriented towards the trailing edge 20 of the wind turbine blade 10.

The first core material 80 and the second core material 80′ each comprises a primary section 82, 82′ and a tapering section 83, 83′. The tapering section 83 of the first core material 80 is arranged adjacent to a longitudinal section of the leading edge side 68 of the body section 65, and the tapering section 83′ of the second core material 80′ is arranged adjacent to a longitudinal section of the trailing edge side 69 of the body section 65. Each tapering section 83, 83′ extends from the respective primary section 82, 82′ to the primary laminate 60 and tapers in thickness from the height H_{SC} of the respective primary section 82, 82′ to the height H_{SC} of the respective one of the leading edge side 68 and the trailing edge side 69 of the primary laminate 60 so that a top surface 81 of the first core material 80 and a top surface 81′ of the second core material 80′ are both aligned with the adjacent top surface 67 of the primary laminate 60. Thus, the top surfaces 80, 80′ of the core materials 80, 80′ and the top surface 67 of the primary laminate form a single surface 80, 80′, 67 substantially without gaps.

The secondary laminate 70 comprises a plurality of second fibre layers including at least five second fibre layers. The second fibre layers include carbon and/or glass fibre fabric layers oriented unidirectionally along the longitudinal axis L_{SC}. The secondary laminate 70 includes a root section 71 with a root end 72. The root end 72 is intended for being oriented towards the root 16 of the wind turbine blade 10 when incorporated therein. The secondary laminate 70 further comprises a tip section 73 with a tip end 74 for being oriented towards the tip 14 of the wind turbine blade 10 when incorporated therein. The boundaries of the root section 71 and the tip section 73 are similar to the boundaries of the root section 61 and tip section 63 as shown in FIGS. 3 and 4A. The plurality of second fibre layers of the secondary laminate 70 is arranged with ply drops so that the height H_{SL} of the root section 71 and the tip section 73 of the secondary laminate 70 tapers off towards the root end 72 and towards the tip end 74 of the secondary laminate 70, respectively. Thus, the cross-section of the secondary laminate 70 along the longitudinal axis L_{SC} is substantially trapezoidal as seen in FIG. 4A. The degree of tapering towards the root end 72 and the tip end 74 may be symmetrical. In other embodiments, the cross-section of the secondary laminate 70 may be skewed towards the root end 72 or the tip end 74.

The secondary laminate 70 is arranged on the top surface 67 of the primary laminate 60 and on the top surfaces 81, 81′ of the core materials 80, 80′. The secondary laminate 70 thus extends beyond the primary laminate 60 in the width direction W_{SC}, on to the top surface 81, 81′ of the tapering section 83, 83′ and on to the top surface 81, 81′ of the primary sections 82, 82′ of both core materials 80, 80′ as best seen in FIGS. 3 and 4B. The secondary laminate 70 is arranged between the tip section 63 and the root section 61 of the primary laminate 60 and the root end 72 of the secondary laminate 70 is distanced from the boundary (as marked by the dashed line as shown in FIGS. 3 and 4A) of the root section 61 of the primary laminate 60 and the tip end 74 of the secondary laminate 70 is distanced from the boundary (as marked by the dashed line as shown in FIGS. 3 and 4A) of the tip section 63 of the primary laminate 60.

The secondary laminate 70 further includes a leading edge side 78 configured for being oriented towards the leading edge 18 of the wind turbine blade 10 when incorporated therein, and a trailing edge side 79 configured for being oriented towards the trailing edge 20 of the wind turbine blade 10 when incorporated therein. A width W_{PL} of the primary laminate 60 and a width W_{SL} of the secondary laminate 70 extend between the trailing edge side 69, 79 and the leading edge side 68, 78 of the respective one of the primary laminate 60 and the secondary laminate 70, and wherein the widths W_{PL}, W_{SL} are substantially constant along the longitudinal axis L_{SC} from the tip end 64, 74 to the root end 62, 72 of the respective one of the primary laminate 60 and the secondary laminate 70. In other words, the leading edge sides 68, 78 and the trailing edge sides 69, 79 extend in parallel to the longitudinal axis L_{SC}. The width W_{SL} of the secondary laminate 70 is at least 1.5 times the width W_{PL} of the primary laminate 60. The leading and trailing edge sides 78, 79 of the secondary laminate may further be tapering off.

The spar cap 50 as described above can be manufactured as follows. As best seen in FIGS. 4A and 4B, a first mould 90 is provided. The first mould 90 is dedicated for moulding the spar cap 50 and thus not configured for moulding a shell part for the wind turbine blade 10 of FIG. 2. The first mould 90 has a mould surface 91 shaped to correspond to an interior surface of a shell of the wind turbine blade 10. A plurality of dry first fibre layers of the primary laminate 60 is arranged directly on the mould surface 91 in a stack so as to provide the uncured primary laminate with the root section 61, root end 62, tip section 63, tip end 64, body section 65, bottom surface 66, top surface 67, leading edge side 68, and trailing edge side 69 as described above. The first core material 80 and the second core material is arranged adjacent to the respective longitudinal section of the leading edge side 68 and the trailing edge side 69 as described above. A plurality of dry second fibre layers is arranged on to the top surface 67 of the body section 65 of the primary laminate 60 and further on to the first core material 80 and on to the second core material 80′ to form the secondary laminate 70 as best seen in FIGS. 3 and 4B. The first mould surface 91 is then covered by a vacuum foil (not shown) to create a moulding volume which is evacuated to provide a vacuum. The plurality of first fibre layers and the plurality of second fibre layers are infused with a first resin which is cured to form a first polymer matrix 51 as best seen in FIGS. 4A and 4B. Thus, the plurality of first fibre layers forming the primary laminate 60, the plurality of second fibre layers forming the secondary laminate 70, the first core material 80, and the second core material 80′ are co-embedded in the first polymer matrix 51 so as to provide the spar cap 50 for the wind turbine blade 10. The spar cap 50 is then demoulded from the first mould 90.

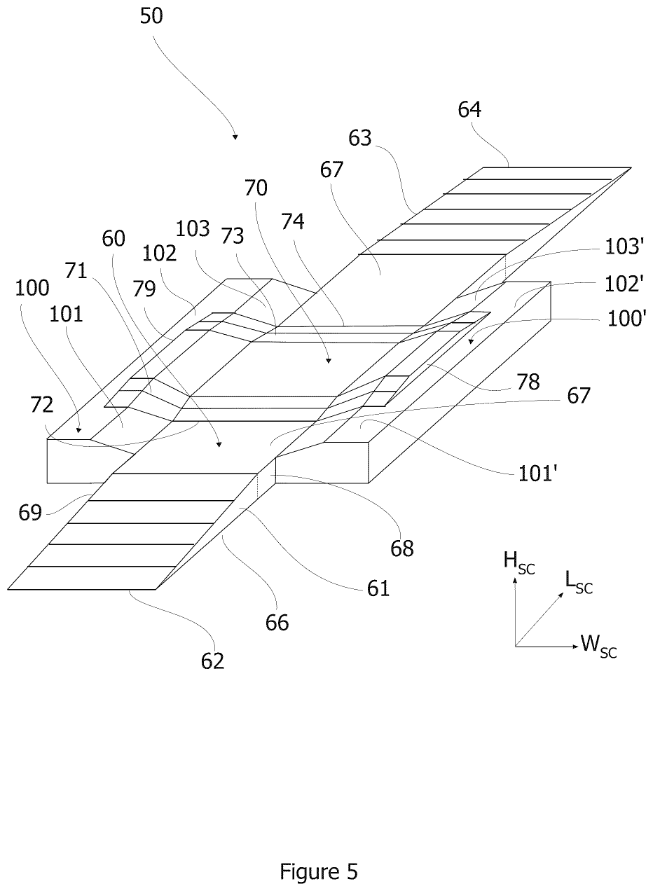

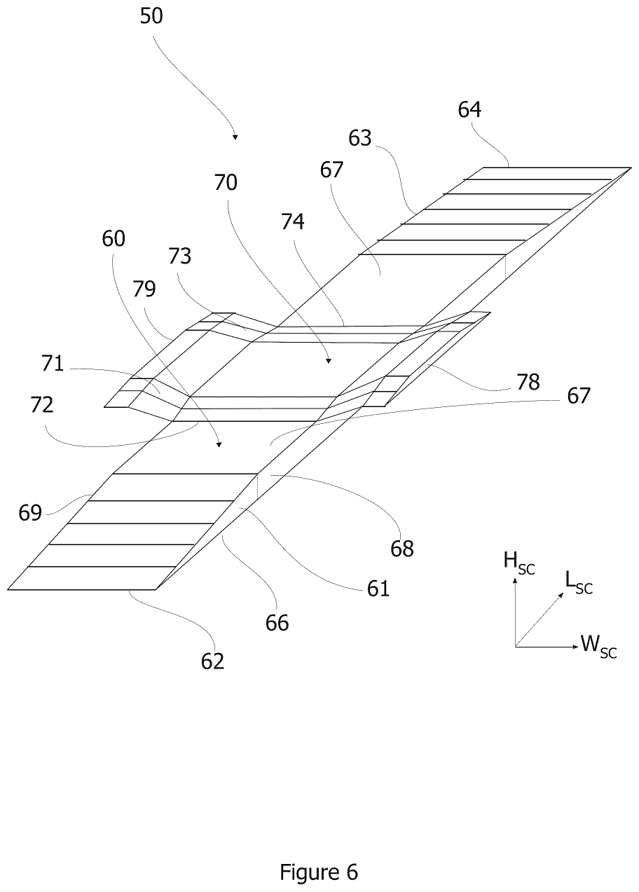

Alternatively, the core materials can be omitted and instead be replaced by mould inlays 100, 100′ having substantially the same dimensions as the core materials 80, 80′ as shown in FIG. 5. Accordingly, the plurality of dry second fibre layers is arranged onto the top surface 67 of the body section 65 of the primary laminate 60 and further onto top surfaces 101, 101′ of tapering sections 103, 103′ and onto top surfaces 81, 81′ of the primary sections 102, 102′ of both mould inlays 100, 100′ to form the secondary laminate 70. The mould inlays 100, 100′ would then be removed after infusing and curing of the primary and secondary laminates 60, 70 as shown in FIG. 6.

The moulded spar cap 50 can be incorporated into a wind turbine blade as follows. A second mould (not shown) is provided with a second mould surface typically coated with a gelcoat. The second mould surface is shaped to correspond to the exterior blade surface 22 of the wind turbine blade 10 as shown in FIG. 2. One or more shell layers, such as carbon or glass fibre layers, is placed onto the coated second mould surface. The moulded spar cap 50 is arranged on the one or more shell layers. Typically, additional core material is arranged adjacent to the core material 80, 80′ of the spar cap 50 or adjacent to the leading edge side 68 and trailing edge side 69 of the primary laminate 60 so as to provide support underneath the secondary laminate 70, if the spar cap 50 was moulded using mould inlays as described above. The spar cap 50, the additional core material, and the one or more shell layers are covered by one or more cover layers, such as glass fibre or carbon fibre layers. The second mould surface is then covered by a vacuum foil to create a moulding volume which is evacuated to provide a vacuum. The one or more shell layers are infused with a second resin that may be the same type as the first resin or may be different. The second resin is cured to form a third polymer matrix in which the one or more shell layers, the one or more cover layers, the additional core material, and the spar cap 50 are co-embedded so as to form a wind turbine blade shell part for the wind turbine blade 10, such as a first shell part including the suction side 24 or a second shell part including the pressure side 26. The first and second shell part are then closed along a bond line extending at the leading edge 18 and the trailing edge 20 to form the wind turbine blade 10. The secondary laminate 70 is arranged so that the root end 72 of the secondary laminate 70 is located at 5% of the total length of the wind turbine blade 10 and the tip end 74 of the secondary laminate is located at 75% of the total length of the wind turbine blade 10.

An alternative embodiment of the spar cap is shown in FIG. 7A. In this embodiment, the primary laminate 60 partially overlaps the secondary laminate 70 in the longitudinal axis L_{SC} (in contrast to FIGS. 3, 4A, 5, and 6). A portion of the primary laminate 60 is arranged on the top surface 77 of the secondary laminate 70. The primary laminate 60 extends further along a tapering tip section 73 of the secondary laminate 70 so that the bottom surface 66 extends along the mould surface 91 as shown. The primary laminate 60 and secondary laminate are co-infused and co-embedded in the same resin. Another embodiment is shown in FIG. 7B in which the tip section 73 of the secondary laminate 70 tapers upwardly (i.e. away from the mould surface 91) instead of downwardly as for the other embodiments. The gaps shown in FIGS. 7A and 7B are heavily exaggerated for illustrative purposes. In practice the fibre layers of the secondary laminates 70 are very thin, in the order of magnitude of hundreds of microns, so the shown gap will in practice be very small. In these particular embodiments, the secondary laminate may consist essentially of a glass fibre reinforced composite and the primary laminate may consist essentially of a carbon fibre reinforced composite. FIG. 7C shows a cross-section at line C-C of FIGS. 7A and 7B (since the cross-section is the same for both embodiments).

In all shown embodiments, the maximum height H_{SC} of the spar cap 50 at the overlap is the sum of the height H_{PL} of the plurality of first fibre layers of the primary laminate 60 and the height H_{SL} of the plurality of second fibre layers of the secondary laminate 70 as best seen in FIG. 7C. As seen, the width W_{SC} of the spar cap is defined by the width W_{SL} of the secondary laminate 70 (i.e. the maximum width of the plurality of second fibre layers of the secondary laminate 70).

The following list of items defines advantageous embodiments of the present disclosure:

1. A separately moulded spar cap for a wind turbine blade, the wind turbine blade extending along a longitudinal blade axis from a root to a tip, the wind turbine blade comprising a root region and an airfoil region with the tip, the wind turbine blade comprising a chord line extending between a leading edge and a trailing edge, the wind turbine blade comprising an aerodynamic exterior blade surface including a pressure side and a suction side, the spar cap extending along a longitudinal axis configured to be parallel to the longitudinal blade axis when the spar cap forms part of the wind turbine blade, the spar cap comprising:
a primary laminate comprising a plurality of first fibre layers embedded in a first polymer matrix, the primary laminate including:
   a root section with a root end configured for being oriented towards the root of the wind turbine blade,
   a tip section with a tip end configured for being oriented towards the tip of the wind turbine blade,
   a body section between the root section and the tip section, the body section having a bottom surface and a top surface, wherein the bottom surface is configured for being adjacent to and oriented towards one of the pressure side and suction side of the wind turbine blade,
   a leading edge side configured for being oriented towards the leading edge of the wind turbine blade, and
   a trailing edge side configured for being oriented towards the trailing edge of the wind turbine blade;
a first core material arranged adjacent to at least a longitudinal section of one of the leading edge side and the trailing edge side of the body section so that a top surface of the first core material is aligned with the adjacent top surface of the body section; and
a secondary laminate comprising a plurality of second fibre layers embedded in a second polymer matrix, the secondary laminate being arranged on the top surface of the primary laminate,
   wherein the first core material is co-embedded in the first polymer matrix and/or the second polymer matrix, and wherein the secondary laminate extends beyond the primary laminate and onto the top surface of the first core material.

2. A spar cap according to item 1, wherein the first polymer matrix is identical to the second polymer matrix so that the secondary laminate is co-embedded with the primary laminate in the same polymer matrix.

3. A spar cap according to any one of the previous items, wherein the body section of the primary laminate has a substantially constant height between the bottom surface and the top surface.

4. A spar cap according to any one of the previous items, wherein a width of the primary laminate and a width of the secondary laminate extend between the trailing edge side and the leading edge side of the respective one of the primary laminate and the secondary laminate, and wherein the widths are substantially constant along the longitudinal axis from the tip end to the root end of the respective one of the primary laminate and the secondary laminate, wherein the width of the secondary laminate is at least 1.5 times the width of the primary laminate.

5. A spar cap according to any one of the previous items, further comprising a second core material adjacent to a longitudinal section of the other one of the leading edge side and the trailing edge side of the primary laminate so that a top surface of the second core material is aligned with the top surface of the body section of the primary laminate, wherein the secondary laminate extends beyond the primary laminate and onto the second core material, wherein the second core material is co-embedded in the first polymer matrix and/or the second polymer matrix.

6. A spar cap according to any one of the previous items, wherein the first core material and/or the second core material each comprises a primary section and a tapering section extending from the primary section to the primary laminate, wherein the tapering section tapers in thickness from the height of the primary section to the height of the respective one of the leading edge side and the trailing edge side of the primary laminate, wherein the secondary laminate extends beyond the primary laminate and onto at least the tapering section of the first core material and/or second core material and preferably on to the primary section of the first core material and/or second core material.

7. A spar cap according to any one of the previous items, wherein a height of the root section and/or the tip section of the primary laminate tapers off towards the root end and/or towards the tip end of the primary laminate, respectively, and wherein the secondary laminate is arranged between and at a distance from the tip section and/or the root section of the primary laminate.

8. A spar cap according to any one of the previous items, wherein a height of the secondary laminate tapers off towards the root end and/or towards the tip end of the secondary laminate.

9. A spar cap according to any one of the previous items, wherein the secondary laminate is arranged so that, when the spar cap forms part of the wind turbine blade, the root end of the secondary laminate is at a location between 3%-10%, preferably 5%, of the total length of the wind turbine blade.

10. A spar cap according to any one of the previous items, wherein the secondary laminate is arranged so that, when the spar cap is incorporated into the wind turbine blade, the tip end of the secondary laminate is at a location between 65%-85%, preferably 75%, of the total length of the wind turbine blade.

11. A wind turbine blade extending along a longitudinal axis from a root to a tip, the wind turbine blade comprising a root region and an airfoil region with the tip, the wind turbine blade comprising a chord line extending between a leading edge and a trailing edge, the wind turbine blade comprising an aerodynamic exterior blade surface including a pressure side and a suction side, the wind turbine blade comprising one or more spar caps according to any one of the previous items, the one or more spar caps including a first spar cap, wherein the bottom surface of the primary laminate of the first spar cap is arranged adjacent to and oriented towards one of the pressure side and suction side of the wind turbine blade.

12. A wind turbine blade according to item 11, wherein the one or more spar caps further include a second spar cap, wherein the bottom surface of the primary laminate of the second spar cap is arranged adjacent to and oriented towards the other one of the pressure side and suction side of the wind turbine blade.

13. A method of offline moulding a spar cap for a wind turbine blade, the wind turbine blade extending along a longitudinal axis from a root to a tip, the wind turbine blade comprising a root region and an airfoil region with the tip, the wind turbine blade comprising a chord line extending between a leading edge and a trailing edge, the wind turbine blade comprising an aerodynamic exterior blade surface including a pressure side and a suction side, the method comprising the steps of:
providing a first mould with a mould surface, the mould surface being shaped to correspond to an interior surface of a shell of the wind turbine blade;
arranging a plurality of first fibre layers directly on the mould surface for forming a primary laminate having:
   a root section with a root end adapted for being oriented towards the root of the wind turbine blade,
   a tip section with a tip end adapted for being oriented towards the tip of the wind turbine blade,
   a body section extending between the root section and the tip section, the body section having a bottom surface and a top surface, the bottom surface being adjacent to and oriented towards one of the pressure side and suction side of the wind turbine blade,
   a leading edge side adapted for being oriented towards the leading edge of the wind turbine blade, and
   a trailing edge side adapted for being oriented towards the trailing edge of the wind turbine blade;
arranging a first core material on the mould surface adjacent to at least a longitudinal section of one of the leading edge side or the trailing edge side of the primary laminate so that a top surface of the first core material is aligned with an adjacent top surface of the body section of the primary laminate;
arranging a plurality of second fibre layers onto the body section of the primary laminate and further onto the first core material to form a secondary laminate;
infusing the plurality of first fibre layers and the plurality of second fibre layers with a resin; and
curing the resin to form a first polymer matrix so that the plurality of first fibre layers forming the primary laminate, the plurality of second fibre layers forming the secondary laminate, and the first core material are co-embedded in the first polymer matrix so as to provide the spar cap for the wind turbine blade.

14. A method according to item 13, comprising a step of arranging a second core material on the mould surface adjacent to the other one of the leading edge side and the trailing edge side of the primary laminate so that a top surface of the second core material is aligned with the top surface of the body section of the primary laminate, wherein the plurality of second fibre layers is further arranged onto the second core material, and wherein the second core material is co-embedded together with the primary laminate, the secondary laminate, and the first core material in the first polymer matrix.

15. A method according to any one of items 13-14, comprising:
demoulding the spar cap;
arranging the spar cap on one or more shell layers in a second mould, the second mould being different from the first mould;
infusing the one or more shell layers with a resin; and
curing the resin to form a third polymer matrix in which the one or more shell layers and the spar cap are co-embedded so as to form a wind turbine blade shell part for the wind turbine blade.

LIST OF REFERENCES

| | |
|---|---|
| 2 | wind turbine |
| 4 | tower |
| 6 | nacelle |
| 8 | hub |
| 10 | blade |
| 13 | shell |
| 14 | blade tip |
| 15 | tip end |
| 16 | blade root |
| 17 | root end |
| 18 | leading edge |
| 20 | trailing edge |
| 22 | exterior blade surface |
| 24 | pressure side |
| 26 | suction side |
| 30 | root region |
| 32 | transition region |
| 34 | airfoil region |
| 36 | tip region |
| 40 | shoulder |
| 50 | spar cap |
| 51 | polymer matrix |
| 60 | primary laminate |
| 61 | root section |
| 62 | root end |
| 63 | tip section |
| 64 | tip end |
| 65 | body section |
| 66 | bottom surface |
| 67 | top surface |
| 68 | leading edge side |
| 69 | trailing edge side |
| 70 | secondary laminate |
| 71 | root section |
| 72 | root end |
| 73 | tip section |
| 74 | tip end |
| 75 | body section |
| 76 | bottom surface |
| 77 | top surface |
| 78 | leading edge side |
| 79 | trailing edge side |
| 80 | core material |
| 81 | top surface |
| 82 | primary section |
| 83 | tapering section |
| 90 | mould |
| 91 | mould surface |
| 100 | mould inlay |
| 101 | top surface |
| 102 | primary section |
| 103 | tapering section |
| L | longitudinal blade axis |
| L_{SC} | longitudinal axis |
| H_{SC} | height of spar cap |
| W_{SC} | width of spar cap |
| L_{PL} | length of primary laminate |
| H_{PL} | height of primary laminate |
| W_{PL} | width of primary laminate |
| L_{SL} | length of secondary laminate |
| H_{SL} | height of secondary laminate |
| W_{SL} | width of secondary laminate |

1-28. (canceled)

29. A spar cap (50) for a wind turbine blade (10), the wind turbine blade extending along a longitudinal blade axis (L) from a root (16) to a tip (14), the wind turbine blade (10) comprising a root region (30) and an airfoil region (34) with the tip (14), the wind turbine blade (10) comprising a chord line extending between a leading edge (18) and a trailing edge (20), the wind turbine blade (10) comprising an aerodynamic exterior blade surface (22) including a pressure side (24) and a suction side (26), the spar cap extending along a longitudinal axis (L_{SC}) configured to be parallel to the longitudinal blade axis (L) when the spar cap (50) forms part of the wind turbine blade (10), the spar cap (50) comprising a load-carrying structure including:
a primary laminate (60) comprising a plurality of first fibre layers embedded in a first polymer matrix (51); and
a secondary laminate (70) comprising a plurality of second fibre layers embedded in a second polymer matrix (51′);
wherein a width (W_{PL}) of the primary laminate (60) and a width (W_{SL}) of the secondary laminate (70) extend between a trailing edge side (69, 79) and a leading edge side (68, 78) of the respective one of the primary laminate (60) and the secondary laminate (70), the width (W_{SL}) of the secondary laminate (70) being at least 1.1 times greater than the width (W_{PL}) of the primary laminate (60), wherein the primary laminate (60) and the secondary laminate (70) overlap in the longitudinal axis (L_{SC}) of the spar cap.

30. A spar cap according to claim 29, wherein the spar cap is a separately moulded spar cap.

31. A spar cap according to claim 29, wherein a bottom surface (76) of the secondary laminate (70) is arranged on the top surface (67) of the primary laminate (60).

32. A spar cap according to claim 29, wherein a bottom surface (66) of the primary laminate (60) is arranged on a top surface (77) of the secondary laminate (70).

33. A spar cap according to claim 29, further comprising a first core material (80) arranged adjacent to at least a longitudinal section of one of the leading edge side (68) and the trailing edge side (69) of a body section (65) so that a top surface (81) of the first core material (80) is aligned with an adjacent top surface (67) of the body section (65), wherein the first core material (80) is co-embedded in the first polymer matrix (51) and/or the second polymer matrix (51′), wherein the secondary laminate (70) extends beyond the primary laminate (60) and onto the top surface (81) of the first core material (80).

34. A spar cap according to claim 29, wherein the width (WPL) of the primary laminate and/or the width (WSL) of the secondary laminate is/are substantially constant along the longitudinal axis (LSC) from the tip end (64, 74) to the root end (62, 72) of the respective one of the primary laminate (60) and the secondary laminate (70) and/or along the height (HSC) of the spar cap.

35. A spar cap according to claim 29, wherein the width (WPL) of the primary laminate and/or the width (WSL) of the secondary laminate is/are substantially constant along the height (HSC) of the spar cap.

36. A spar cap according to claim 29, wherein the width (WSL) of the secondary laminate (70) is at least 1.5 times the width (WPL) of the primary laminate (60).

37. A spar cap according to claim 33, wherein the first core material (80) and/or a second core material (80′) each comprises a primary section (82, 82′) and a tapering section (83, 83′) extending from the primary section (82, 82′) to the primary laminate (60), wherein the tapering section (83, 83′) tapers in thickness from the height (HSC) of the primary section (82, 82′) to the height (HSC) of the respective one of the leading edge side (68) and the trailing edge side (69) of the primary laminate (60), wherein the secondary laminate (70) extends beyond the primary laminate (60) and on to at least the tapering section (83, 83′) of the first core material (80) and/or second core material (80′).

38. A spar cap according to claim 29, wherein a height (HSL) of the secondary laminate (70) tapers off towards a root end (72) and/or towards a tip end (74) of the secondary laminate (70).

39. A spar cap according to claim 29, wherein the secondary laminate (70) is arranged so that, when the spar cap (50) forms part of the wind turbine blade (10), a root end (72) of the secondary laminate (70) is at a location between 3%-10% of the total length of the wind turbine blade (10), and/or wherein the secondary laminate (70) is arranged so that, when the spar cap (50) is incorporated into the wind turbine blade (10), the tip end (74) of the secondary laminate (70) is at a location between 65%-85% of the total length of the wind turbine blade (10).

40. A wind turbine blade extending along a longitudinal axis (L) from a root (16) to a tip (14), the wind turbine blade (10) comprising a root region (30) and an airfoil region (34) with the tip (14), the wind turbine blade (10) comprising a chord line extending between a leading edge (18) and a trailing edge (20), the wind turbine blade (10) comprising an aerodynamic exterior blade surface (22) including a pressure side (24) and a suction side (26), the wind turbine blade comprising one or more spar caps (50) according to any one of the previous claims, the one or more spar caps including a first spar cap (50), wherein a bottom surface (66) of the primary laminate (60) of the first spar cap (50) is arranged adjacent to and oriented towards one of the pressure side (24) and suction side (26) of the wind turbine blade (10).

41. A wind turbine blade according to claim 40, wherein the spar cap is covered by one or more cover layers.

42. A method of moulding a spar cap for a wind turbine blade, the wind turbine blade extending along a longitudinal axis (L) from a root (16) to a tip (14), the wind turbine blade (10) comprising a root region (30) and an airfoil region (34) with the tip (14), the wind turbine blade (10) comprising a chord line extending between a leading edge (18) and a trailing edge (20), the wind turbine blade (10) comprising an aerodynamic exterior blade surface (22) including a pressure side (24) and a suction side, the method comprising the steps of:
providing a first mould (90) with a mould surface (91), the mould surface being shaped to correspond to an interior surface of a shell of the wind turbine blade;
arranging a plurality of first fibre layers, preferably directly, on the mould surface for forming a primary laminate (60);
arranging a plurality of second fibre layers in the mould for forming a secondary laminate (70);
embedding, and preferably infusing, the plurality of first fibre layers and the plurality of second fibre layers in a resin; and
curing the resin to form a first polymer matrix (51) so that the plurality of first fibre layers forming the primary laminate (60) and the plurality of second fibre layers forming the secondary laminate (70) are co-embedded in the first polymer matrix (51) so as to form a load-carrying structure of the spar cap (50) for the wind turbine blade (10), wherein a width (WSL) of the second laminate being at least 1.1 times a width (WPL) of the primary laminate (60), wherein the primary laminate (60) and the secondary laminate (70) overlap in the longitudinal axis (LSC) of the spar cap.

43. A method according to claim 42, further comprising a step of:
arranging a first mould inlay on the mould surface (91) adjacent to at least a longitudinal section of one of the leading edge side (68) or the trailing edge side (69) of the primary laminate (60) so that a top surface (81) of the first mould inlay is aligned with an adjacent top surface (67) of the body section (65) of the primary laminate (60),
wherein the plurality of second fibre layers is arranged onto the body section (65) of the primary laminate and further onto the first mould inlay, wherein the method preferably comprises a step of removing the first mould inlay after the step of infusion or curing.

44. A method according to claim 43, comprising a step of arranging a second mould inlay (80′) on the mould surface (91) adjacent to the other one of the leading edge side (68) and the trailing edge side (69) of the primary laminate (60) so that a top surface (81′) of the second core material (80′) is aligned with the top surface (67) of the body section (65) of the primary laminate (60), wherein the plurality of second fibre layers is further arranged onto the second core material (80′), and wherein the second core material (80′) is co-embedded together with the primary laminate (60), the secondary laminate (70), and the first core material (80) in the first polymer matrix (51).

45. A method according to claim 42, further comprising a step of:
arranging a first core material (80) on the mould surface (91) adjacent to at least a longitudinal section of one of the leading edge side (68) or the trailing edge side (69) of the primary laminate (60) so that a top surface (81) of the first core material (80) is aligned with an adjacent top surface (67) of the body section (65) of the primary laminate (60),
wherein the plurality of second fibre layers is arranged onto the body section (65) of the primary laminate and further onto the first core material (80), wherein the first core material is additionally co-embedded in the first polymer matrix so as to form the load-carrying structure of the spar cap.

46. A method according to claim 45, comprising a step of arranging a second core material (80′) on the mould surface (91) adjacent to the other one of the leading edge side (68) and the trailing edge side (69) of the primary laminate (60) so that a top surface (81′) of the second core material (80′) is aligned with the top surface (67) of the body section (65) of the primary laminate (60), wherein the plurality of second fibre layers is further arranged on to the second core material (80′), and wherein the second core material (80′) is co-embedded together with the primary laminate (60), the secondary laminate (70), and the first core material (80) in the first polymer matrix (51).

47. A method according to claim 42, wherein the method is a method of offline moulding the spar cap for the wind turbine blade.

48. A method according to claim 47, comprising:
demoulding the spar cap (50);
arranging the spar cap (50) on one or more shell layers in a second mould, the second mould being different from the first mould;
infusing the one or more shell layers with a resin; and
curing the resin to form a third polymer matrix in which the one or more shell layers and the spar cap are co-embedded so as to form a wind turbine blade shell part for the wind turbine blade (10).
